(19) United States
(12) Patent Application Publication
(10) Pub. No.: US 2006/0066216 A1
(43) Pub. Date: Mar. 30, 2006

(54) Field emission display

(75) Inventors: Keisuke Koga, Soraku-gun (JP); Akinori Shiota, Ibaraki-shi (JP); Makoto Yamamoto, Takarazuka-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/233,974

(22) Filed: Sep. 23, 2005

(30) Foreign Application Priority Data
Sep. 29, 2004 (JP) 2004-284553

(51) Int. Cl. H01J 63/04; H01J 1/62

(52) U.S. Cl. 313/496

(57) ABSTRACT

There is provided a field emission display that can achieve high brightness without increasing the anode voltage, and can realize high resolution by suppressing the occurrence of inter-pixel crosstalk resulting from light excited from the phosphor layers. A field emission display is constructed by a field emission electron source disposed in a vacuum container and a phosphor screen that is disposed in the vacuum container so as to be opposite to the field emission electron source and that has a plurality of recessed portions on its surface opposing to the field emission electron source, with phosphor layers being formed in the recessed portions An image is displayed by causing the phosphor layers to emit light by collision of electrons emitted from the field emission electron source. The inner wall surface of the recessed portions widens in a tapered shape from the bottom surface side toward the opening side, and adjacent recessed portions are divided by a rib structure made of a material having a light-absorbing effect (Black effect) with respect to light of the light-emitting wavelength. The phosphor layers are formed substantially all over the bottom surface and-the inner wall surface of the recessed portions.

### BACKGROUND OF THE INVENTION

1. Field of the Invention

The present invention relates to a field emission display (FED) utilizing a field emission electron source.

2. Description of Related Art

Conventionally, cathode ray tubes (CRTs) have been the standard for displays (image displays) of color televisions, personal computers and the like. However, with the recent increasing demand for the reduction in the size, weight and thickness of the image displays, various thin image displays are being developed and manufactured.

Under such circumstances, the research and development of a variety of flat panel displays has been conducted recently. In particular, extensive research is being conducted on liquid crystal displays, plasma displays and the like. Liquid crystal displays are applied to various products such as portable personal computers, portable televisions, video cameras and car navigation systems, whereas plasma displays are applied to products such as 20-inch-to 40-inch-class large displays. However, liquid crystal displays have the problems of a narrow viewing angle and a slow response, and plasma displays have the problems, for example, in that high brightness is difficult to achieve and their power consumption is high.

Therefore, as a flat panel display that can solve these problems, an image display utilizing a phenomenon called field emission in which electrons are emitted in a vacuum at room temperature (hereinafter, referred to as “field emission display”) is receiving attention. This field emission display is self-emitting, and therefore can achieve a wide viewing angle and high brightness. Furthermore, its basic principle (causing phosphors to emit light using electron beams) is the same as that of conventional cathode ray tubes, so that it can display an image that is natural and has high color reproducibility.

As a conventional field emission display of this type, a field emission display having a configuration as described below (see e.g., JP2001-110343A) is known. FIG. 7 schematically shows a configuration of a field emission display in the conventional art.

As shown in FIG. 7, a conventional field emission display 200 is provided with a field emission electron source 201 disposed in a vacuum container and a phosphor screen 202 disposed in the vacuum container, opposite to the field emission electron source 201. The field emission electron source 201 includes: a cathode substrate 101; a cathode electrode 102 formed as a thin film on the cathode substrate 101; a conical emitter 105 formed on the cathode electrode 102; a first insulating layer 103 also formed on the cathode electrode 102 so as to surround the emitter 105; and a gate electrode 104 formed on the first insulating layer 103. On the other hand, the phosphor screen 202 includes: an anode substrate 106; an anode electrode 107 that is formed as a thin film on the anode substrate 106; a second insulating layer 108 formed on the anode electrode 107, opposite to the first insulating layer 103; a shield electrode 109 formed on the second insulating layer 108; and a phosphor layer 110 formed on the anode electrode 107 in an opening (recessed portion) formed in the shield electrode 109 and the second insulating layer 108. It should be noted that for simplicity, FIG. 7 shows only the configuration corresponding to a single display pixel. Further, although FIG. 7 shows a configuration including a single emitter, an emitter array usually is configured including a plurality of emitters (namely, several hundreds of emitters per pixel). Here, the shield electrode 109 has a focusing effect that inhibits expansion of the trajectory of electrons emitted from the emitter array.

In the field emission display 200 having the above-described configuration, by applying predetermined voltages (a gate voltage, an anode voltage and a shield voltage) to the gate electrode 104, the anode electrode 107 and the shield electrode 109, respectively, electrons having a certain divergence angle that are emitted from the emitter 105 are focused by the shield electrode 109, while being accelerated in the direction of the anode substrate 106, so that they collide with the phosphor layer 110. Consequently, the phosphor layer 110 emits light, and an image is displayed.

When a field emission display having the above-described configuration is used in applications requiring a high brightness of at least 1×10⁴ cd/m², it is necessary to set the anode voltage to at least 5 kV.

However, in the case of a field emission display having the above-described configuration, although it is possible to set the potential of the shield electrode to an optimum value when the anode voltage is in the range of 1 kV or lower, it is difficult to set the potential of the shield electrode to an optimum value when the anode voltage is in a high voltage region of 5 kV or higher, since it is not possible to maintain the withstand voltage between the shield electrode and the anode electrode safely. If the potential of the shield electrode cannot be set to an optimum value, then the focusing performance of the shield electrode decreases, so that inter-pixel crosstalk occurs, which undesirably causes a pixel that is adjacent to the actual light-emitting pixel to emit light. This leads to degradation of the resolution.

Therefore, in view of such problems, a field emission display that can achieve high brightness without increasing the anode voltage has been proposed (see e.g., JP2004-47140A). FIG. 8 schematically shows a configuration of this field emission display on the phosphor screen side.

As shown in FIG. 8, a phosphor screen 219 of this field emission display includes: a transparent substrate 220; a black matrix layer 221 that is formed on one surface of the transparent substrate 220 and includes a plurality of openings 226; phosphor layers 227R, 227 G and 227B that are formed at least in the openings 226 of the black matrix layer 221; a plurality of barriers 225 that are formed at predetermined positions on the black matrix layer 221 and made of an inorganic conductive material; and an intermediate layer 224 that is provided between the barriers 225 and the black matrix layer 221 and made of an inorganic conductive material. The surface of the barriers 225 is tapered to have a tapered angle from 45° to 80° relative to the surface of the transparent substrate 220. Additionally, the intermediate layer 224 is made up of an undercoat layer 222 and a conductive layer 223.

With the configuration of the field emission display shown in FIG. 8, it is possible to improve the emission brightness, because the tapered surface of the barriers 225 enables a significant increase of the effective surface area of the phosphor layers 227R, 227G and 227B of the phosphor screen 219 that correspond to each pixel. Consequently, it is possible to realize a field emission display that can achieve high brightness without increasing the anode voltage.

When electrons that are emitted from a field emission electron source hit a phosphor layer, these electrons have sufficient excitation energy, so that light with a wavelength in the visible band is excited from the phosphor layer. Upon reaching the adjacent pixel, this excited light becomes a stray light component, causing inter-pixel crosstalk.

Nevertheless, in the case of the field emission display having the configuration shown in FIG. 8, the black matrix layer 221, which has a light-absorbing effect, has a planar structure, and therefore can only exert its light-absorbing effect for external light entering mainly from the transparent substrate 220, and has yet to prevent inter-pixel crosstalk resulting from light excited from the phosphor layers 227R, 227G and 227B.

The present invention has been made in order to solve the above-described problems in the related art, and it is an object of the invention to provide a field emission display that can achieve high brightness without increasing the anode voltage, and can realize high resolution by preventing inter-pixel crosstalk resulting from light excited from phosphor layers.

### SUMMARY OF THE INVENTION

In order to achieve the above-described objects, a first configuration of a field emission display according to the present invention includes: a field emission electron source disposed in a vacuum container; and a phosphor screen that is disposed in the vacuum container, opposite to the field emission electron source, and that has a plurality of recessed portions on its surface opposing the field emission electron source, with phosphor layers being formed in the recessed portions, the field emission display displaying an image by causing the phosphor layers to emit light by collision of electrons emitted from the field emission electron source. An inner wall surface of the recessed portions widens in a tapered shape from the bottom surface side toward the opening side of the recessed portions. The adjacent recessed portions are divided by a rib structure made of a material having a light-absorbing effect (Black effect) with respect to light of the light-emitting wavelength. The phosphor layers are formed substantially all over the bottom surface and the inner wall surface of the recessed portions.

It is preferable that the above-described first configuration of the field emission display according to the present invention further includes an electron beam shield plate that is disposed in the vicinity of the phosphor screen on the field emission electron source side and that has openings corresponding to an opening size of the recessed portions. With this preferable configuration, by applying an intermediate (positive) voltage between the outgoing voltage (gate voltage) and the anode voltage to the electron beam shield plate, electrons that are emitted from the field emission electron source move straight ahead, with no lens effect exerted thereon, and only peripheral electrons are shielded (blocked) mechanically by the spatial filtering effect of the electron beam shield plate. Consequently, it is possible to prevent the electron beam from entering the adjacent pixel, thus achieving high resolution by suppressing the occurrence of inter-pixel crosstalk. Furthermore, in this case, it is preferable that a getter film having a gas-adsorbing effect is formed on at least one surface of the electron beam shield plate. According to this preferable configuration, outgassing components that are produced by, for example, the collision of electrons on the phosphor layer can be absorbed efficiently, so that the vacuum degree in the field emission display can be maintained favorably. As a result, it is possible to prevent the emitters constituting the field emission electron source from becoming inoperable due to discharge breakdown, thus making it possible to extend the life of the field emission electron source and that of the field emission display as well.

It is preferable that the above-described first configuration of the field emission display according to the present invention further includes an electron beam shield plate that is disposed in contact with the phosphor screen on the field emission electron source side and that has openings corresponding to an opening size of the recessed portions. Furthermore, in this case, it is preferable that a getter film having a gas-adsorbing effect is formed on a surface of the electron beam shield plate that is on the field emission electron source side.

In the above-described first configuration of the field emission display according to the present invention, it is preferable that the plurality of the recessed portions is arranged in a matrix form or a line form.

With the present invention, the effective surface area of the phosphor layers of the phosphor screen that correspond to each pixel can be increased significantly, and it is therefore possible to improve the emission brightness. Consequently, it is possible to realize a field emission display that can achieve high brightness without increasing the anode voltage. Furthermore, since the inner wall surface of each of the recessed portions in which the phosphor layers are formed widens in a tapered shape from the bottom surface side toward the opening side of the recessed portions, an electron beam (reflection component) that has been reflected after entering each of the phosphor layers on the inner wall surface of the recessed portions can be made incident again on the same phosphor layer in the recessed portions, and this also makes it possible to achieve an improved emission brightness. Furthermore, since the adjacent recessed portions are divided by a rib structure made of a material having a light-absorbing effect (Black effect) with respect to light of the light-emitting wavelength, it is possible to achieve high brightness by suppressing the occurrence of inter-pixel crosstalk resulting from light excited from the phosphor layers.

A second configuration of a field emission display according to the present invention includes: a field emission electron source disposed in a vacuum container; and a phosphor screen that is disposed in the vacuum container, opposite to the field emission electron source and that has a plurality of recessed portions on its surface opposing to the field emission electron source, with phosphor layers being formed in the recessed portions, the field emission display displaying an image by causing the phosphor layers to emit light by collision of electrons emitted from the field emission electron source. An inner wall surface of the recessed portions widens in a tapered shape from the bottom surface side toward the opening side of the recessed portions. The phosphor layers are formed substantially all over the bottom surface and the inner wall surface of the recessed portions. The second configuration of a field emission display further includes an electron beam shield plate that is disposed in the vicinity of the phosphor screen on the field emission electron source side and that has openings corresponding to an opening size of the recessed portions, and a getter film has a gas-adsorbing effect is formed on at least one surface of the electron beam shield plate.

A third configuration of a field emission display according to the present invention includes: a field emission electron source disposed in a vacuum container; and a phosphor screen that is disposed in the vacuum container, opposite to the field emission electron source and that has a plurality of recessed portions on its surface opposing to the field emission electron source, with phosphor layers being formed in the recessed portions, the field emission display displaying an image by causing the phosphor layers to emit light by collision of electrons emitted from the field emission electron source. An inner wall surface of the recessed portions widens in a tapered shape from the bottom surface side toward the opening side of the recessed portions. The phosphor layers are formed substantially all over the bottom surface and the inner wall surface of the recessed portions. The third configuration of a field emission display further includes an electron beam shield plate that is disposed in contact with the phosphor screen on the field emission electron source side and that has openings corresponding to an opening size of the recessed portions, and a getter film having a gas-adsorbing effect is formed on a surface of the electron beam shield plate that is on the field emission electron source side.

### BRIEF DESCRIPTION OF THE DRAWINGS

FIG. 1 is a cross-sectional view schematically showing a configuration of a field emission display according to one embodiment of the present invention.

FIG. 2 is a perspective view showing the shape of recessed portions forming phosphor layers of the field emission display according to one embodiment of the present invention.

FIG. 3 is a front view showing the recessed portions forming the phosphor layers of the field emission display according to one embodiment of the present invention.

FIGS. 4A to 4D are diagrams showing the steps of producing the phosphor screen of the field emission display according to one embodiment of the present invention.

FIG. 5 is a perspective view showing another example of the shape of the recessed portions forming the phosphor layers of the field emission display according to one embodiment of the present invention.

FIG. 6 is a cross-sectional view schematically showing another configuration of a field emission display according to one embodiment of the present invention.

FIG. 7 is a cross-sectional view schematically showing a configuration of a field emission display according to the conventional art.

FIG. 8 is a cross-sectional view schematically showing another configuration of a field emission display according to the conventional art.

### DETAILED DESCRIPTION OF THE INVENTION

Hereinafter, the present invention will be described more specifically by way of an embodiment with reference to the accompanying drawings.

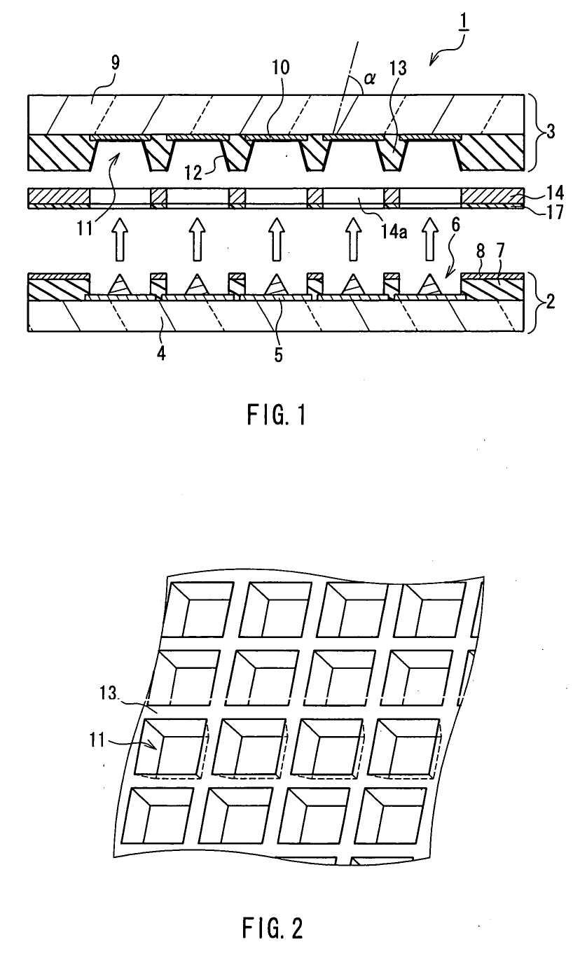

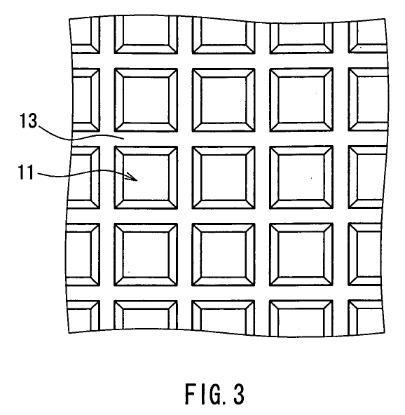

FIG. 1 is a cross-sectional view schematically showing a configuration of a field emission display according to one embodiment of the present invention, FIG. 2 is a perspective view showing the shape of recessed portions forming phosphor layers of the above-mentioned field emission display, and FIG. 3 is a front view showing the above-mentioned recessed portions.

As shown in FIG. 1, a field emission display 1 according to this embodiment is provided with a field emission electron source 2 disposed in a vacuum container (not shown), and a phosphor screen 3 disposed in the vacuum container so as to be opposite to the field emission electron source 2.

The field emission electron source 2 includes: a cathode substrate 4 made of glass or the like; cathode electrodes 5 that are made of a metal film or the like formed as a thin film on the cathode substrate 4; a plurality of cathode portions 6 formed on the cathode electrodes 5; an insulating layer 7 that is made of an insulating film of silicon oxide or the like also formed on the cathode electrodes 5, surrounding the cathode portions 6; and a gate electrode 8 that is made of a film of, for example, Nb metal or polysilicon formed on the insulating layer 7. Here, the cathode portions 6 are arranged in a matrix form, and each of the cathode portions 6 is configured as an emitter array that includes a plurality of conical emitters (namely, several hundreds of emitters per pixel) constituted by a high-melting metal such as molybdenum, or a semiconductor such as silicon. Further, the gate electrode 8 serves as an outgoing electrode for applying a voltage to each of the emitters such that electrons are emitted from the tip of each emitter.

The phosphor screen 3 includes: an anode substrate 9 made of glass or the like; anode electrodes 10 that are formed by, for example, a metal film formed as a thin film on the anode substrate 9; a plurality of recessed portions 11 formed on the anode electrodes 10, opposite to the respective cathode portions 6; and phosphor layers 12 formed in the recessed portions 11. That is, each of the recessed portions 11, in which the phosphor layers 12 are formed, corresponds to a single display pixel, and the recessed portions 11 are arranged in a matrix form, as with the cathode portions 6 (see FIG. 2 and FIG. 3). Additionally, the adjacent recessed portions 11 are divided by a rib structure 13, which forms the inner surface wall of each of the recessed portions 11.

In the field emission display 1 having the above-described configuration, by applying predetermined voltages (a gate voltage and an anode voltage) to the gate electrodes 8 and the anode electrodes 10, respectively, electrons that are emitted from each of the cathode portions 6 of the field emission electron source 2 are accelerated in the direction of the phosphor screen 3 and then collide with the corresponding phosphor layer 12, thereby causing the phosphor layers 12 to emit light to display an image.

As shown in FIG. 1 to FIG. 3, the recessed portions 11, in which the phosphor layers 12 are formed, are formed in the shape of a so-called truncated quadrangular pyramid (frusto-pyramidal shape) whose cross section perpendicular to the straight line connecting the center of each pair of the cathode portion 6 and the recessed portion 11 has a rectangular shape and whose inner wall surface widens in a tapered shape from its bottom surface side toward its opening side. Further, the phosphor layers 12 are formed substantially all over the bottom surface and the inner wall surface of the recessed portions 11. By forming the area in which the phosphor layers 12 are formed in such a configuration, it is possible to increase the effective surface area of the phosphor layers 12 of the phosphor screen 3 that correspond to each pixel by as much as about 30 to 40%, so that the emission brightness can be improved more than was conventionally possible. Consequently, it is possible to achieve a field emission display 1 that can realize high brightness without increasing the anode voltage applied to the anode electrodes 10. Furthermore, since the inner wall surface of the recessed portions 11, in which the phosphor layers 12 are formed, widens in a tapered shape from the bottom surface side toward the opening side in this way, an electron beam (reflection component) that has been reflected after entering each of the phosphor layers 12 on the inner wall surface of the recessed portions 11 can be made incident again on the same phosphor layer 12 in the recessed portions 11, and this also makes it possible to achieve an improved emission brightness.

Preferably, the tapered angle α of the inner wall surface of the recessed portions 11 is in the range of 60°<α<90°. Since the phosphor layers 12 are formed on the bottom surface and the tapered inner wall surface of the recessed portions 11, it is preferable to increase the tapered angle α, in order to increase the effective surface area of the phosphor layers 12 of the phosphor screen 3 that correspond to each pixel. On the other hand, increasing the tapered angle α gives rise to the problem of increased technical difficulty of the formation process. By using a sandblasting technique used for the rib formation for plasma display panels (PDPs), it is possible to perform processing that provides a tapered angle α of 60° or more.

When electrons that are emitted from the cathode portions 6 of the field emission electron source 2 collide with the phosphor layers 12, these electrons have sufficient excitation energy, so that light with a wavelength in the visible band is excited from the phosphor layers 12. Then, upon reaching the adjacent pixel, this excited light becomes a stray light component, causing inter-pixel crosstalk. In order to prevent the occurrence of this crosstalk, the rib structure 13 dividing the adjacent recessed portions 11 is formed of a material having a light-absorbing effect (Black effect) with respect to light with a wavelength in the visible band (light-emitting wavelength). Examples of a suitable material having a light-absorbing effect (Black effect) include a black matrix resist, which is used commonly for the phosphor screens of CRTs. By using a material having a light-absorbing effect to light with a wavelength in the visible band (light-emitting wavelength) to form the rib structure 13 forming the inner wall surface of each of the recessed portions 11 in this way, it is possible to achieve high resolution by suppressing the occurrence of inter-pixel crosstalk resulting from light excited from the phosphor layers 12.

Preferably, an electron shield plate 14 that has openings 14a corresponding to the size of the opening surface (opening size) of the recessed portions 11 is disposed in the vicinity of the phosphor screen 3 on the field emission electron source 2 side. With this preferable configuration, by applying an intermediate (positive) voltage between the outgoing voltage (gate voltage) and the anode voltage to the electron beam shield plate 14, electrons that are emitted from the field emission electron source 2 move straight ahead, with no lens effect exerted thereon, and only peripheral electrons are shielded (blocked) mechanically by the spatial filtering effect of the electron beam shield plate 14. Consequently, it is possible to prevent the electron beam from entering the adjacent pixel, thus achieving even higher resolution by suppressing the occurrence of inter-pixel crosstalk.

As described above, with the configuration according to this embodiment, it is possible to realize a field emission display 1 that can achieve high brightness and high resolution at the same time.

Furthermore, when electrons that are emitted from the cathode portions 6 of the field emission electron source 2 collide with the phosphor layers 12, gas components are released into the field emission display 1 and thus the vacuum degree decreases, which in the worst case renders the emitters constituting the cathode portions 6 inoperable due to discharge breakdown. To prevent such a decrease in the vacuum degree, it is preferable to form a getter film 17 having a gas-adsorbing effect on at least one surface of the electron beam shield plate 14 disposed in the vicinity of the phosphor screen 3. Since the gettering effect of the getter film 17 greatly varies depending on the gas component, it is important to select an optimum material as the material of the getter film 17. As the material of the getter film 17, a Ba compound material and a Ti compound material, for example, can be used. By forming the getter film 17 having the gas-adsorbing effect on the surface of the electron beam shield plate 14 disposed in the vicinity of the phosphor screen 3 in this way, outgassing components that are produced by, for example, the collision of electrons with the phosphor layer 12 can be absorbed efficiently, so that the vacuum degree in the field emission display 1 can be maintained favorably. As a result, it is possible to prevent the emitters constituting the cathode portions 6 of the field emission electron source 2 from becoming inoperable due to discharge breakdown, thus making it possible to extend the life of the field emission electron source 2 and that of the field emission display 1 as well.

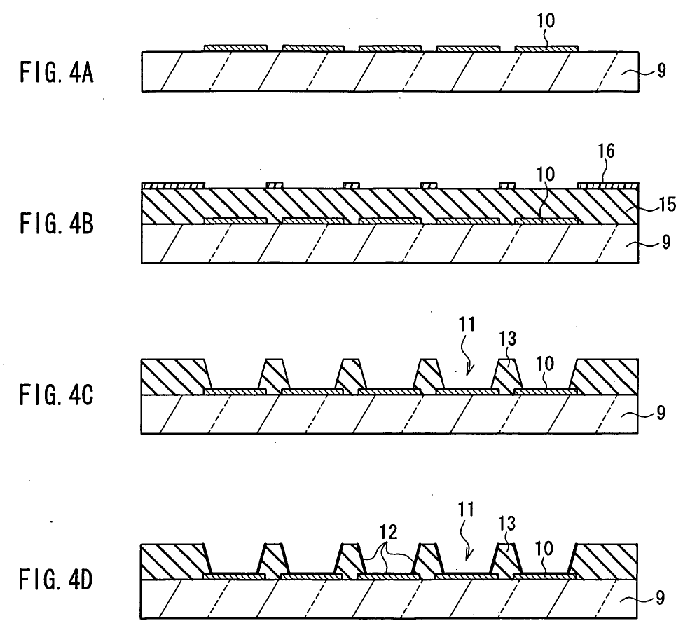

Here, a method for producing the phosphor screen 3 will be described with reference to FIG. 4.

First, as shown in FIG. 4A, an ITO thin film, for example, is formed as a transparent conductive film on an anode substrate 9 made of glass by vapor deposition, for example, and the film is removed selectively by etching, thereby forming anode electrodes 10.

Next, as shown in FIG. 4B, on the anode substrate 9, on which the anode electrodes 10 are formed, a sheet-like dielectric material 15 containing a material having a light-absorbing effect to light with a wavelength in the visible band (light-emitting wavelength) is formed as a film with a desired thickness (100 μm) by a bonding process. Then, a mask pattern 16, serving as the etching mask in the subsequent step, is formed by photolithography using a thick-film resist.

Next, as shown in FIG. 4C, an etching process is performed under optimum processing conditions using sandblasting, and thereafter the mask pattern 16 is removed. Consequently, recessed portions 11 having a tapered inner wall surface are formed.

Finally, as shown in FIG. 4D, three types of phosphors that emit light of R (red), G (green) and B (blue) successively are printed substantially all over the bottom surface and the inner wall surface of the recessed portions 11 using screen printing, thereby forming phosphor layers 12.

It should be noted that although the recessed portions 11 are formed in the shape of a truncated quadrangular pyramid in this embodiment, the recessed portions are not necessarily limited to this configuration, and may be in the shape of a truncated cone or a truncated polygonal pyramid, for example.

Further, although the recessed portions 11 in which the phosphor layers 12 are formed are arranged in a matrix form so as to correspond to each pixel in this embodiment, the recessed portions 11 are not necessarily limited to this configuration, and may be arranged in a line form, as shown in FIG. 5.

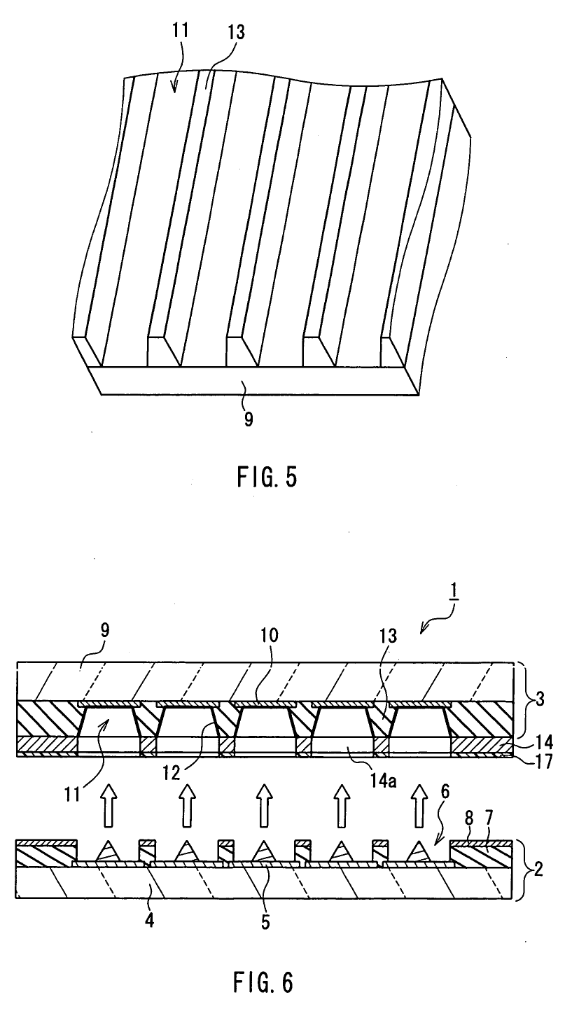

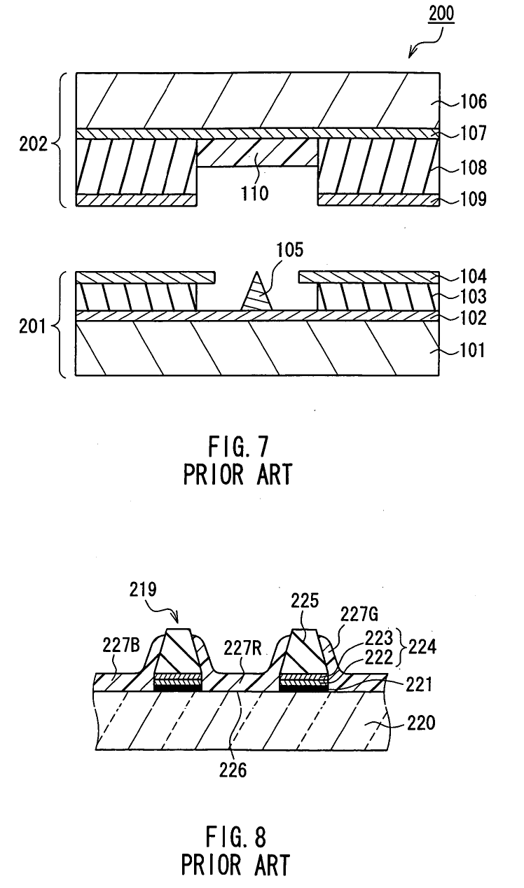

Furthermore, although the electron beam shield plate 14 is spaced apart from the phosphor screen 3 in this embodiment, the electron beam shield plate 14 also may be disposed in contact with the phosphor screen 3, as shown in FIG. 6. In this case, a getter film 17 having a gas-adsorbing effect is formed on the surface of the electron beam shield plate 14 that is on the field emission electron source 2 side.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

What is claimed is:

1. A field emission display comprising:
a field emission electron source disposed in a vacuum container; and
a phosphor screen that is disposed in the vacuum container, opposite to the field emission electron source and that has a plurality of recessed portions on its surface opposing to the field emission electron source, with phosphor layers being formed in the recessed portions,
the field emission display displaying an image by causing the phosphor layers to emit light by collision of electrons emitted from the field emission electron source;
wherein an inner wall surface of the recessed portions widens in a tapered shape from the bottom surface side toward the opening side of the recessed portions, and adjacent recessed portions are divided by a rib structure made of a material having a light-absorbing effect with respect to light of the emitted wavelength; and
wherein the phosphor-layers are formed substantially all over the bottom surface and the inner wall surface of the recessed portions.

2. The field emission display according to claim 1, further comprising:
an electron beam shield plate that is disposed in the vicinity of the phosphor screen on the field emission electron source side and that has openings corresponding to an opening size of the recessed portions.

3. The field emission display according to claim 2,
wherein a getter film having a gas-adsorbing effect is formed on at least one surface of the electron beam shield plate.

4. The field emission display according to claim 1, further comprising:
an electron beam shield plate that is disposed in contact with the phosphor screen on the field emission electron source side and that has openings corresponding to an opening size of the recessed portions.

5. The field emission display according to claim 4,
wherein a getter film having a gas-adsorbing effect is formed on a surface of the electron beam shield plate that is on the field emission electron source side.

6. The field emission display according to claim 1,
wherein the plurality of the recessed portions are arranged in a matrix form.

7. The field emission display according to claim 1,
wherein the plurality of the recessed portions are arranged in a line form.

8. A field emission display comprising:
a field emission electron source disposed in a vacuum container; and
a phosphor screen that is disposed in the vacuum container, opposite to the field emission electron source and that has a plurality of recessed portions on its surface opposing to the field emission electron source, with phosphor layers being formed in the recessed portions,
the field emission display displaying an image by causing the phosphor layers to emit light by collision of electrons emitted from the field emission electron source;
wherein an inner wall surface of the recessed portions widens in a tapered shape from the bottom surface side toward the opening side of the recessed portions, and the phosphor layers are formed substantially all over the bottom surface and the inner wall surface of the recessed portions; and
wherein further comprising an electron beam shield plate that is disposed in the vicinity of the phosphor screen on the field emission electron source side and that has openings corresponding to an opening size of the recessed portions, and a getter film having a gas-adsorbing effect is formed on at least one surface of the electron beam shield plate.

9. A field emission display comprising:
a field emission electron source disposed in a vacuum container; and
a phosphor screen that is disposed in the vacuum container, opposite to the field emission electron source and that has a plurality of recessed portions on its surface opposing to the field emission electron source, with phosphor layers being formed in the recessed portions,
the field emission display displaying an image by causing the phosphor layers to emit light by collision of electrons emitted from the field emission electron source;
wherein an inner wall surface of the recessed portions widens in a tapered shape from the bottom surface side toward the opening side of the recessed portions, and the phosphor layers are formed substantially all over the bottom surface and the inner wall surface of the recessed portions; and
wherein further comprising an electron beam shield plate that is disposed in contact with the phosphor screen on the field emission electron source side and that has openings corresponding to an opening size of the recessed portions, and a getter film having a gas-adsorbing effect is formed on a surface of the electron beam shield plate that is on the field emission electron source side.
